(19) United States
(12) Patent Application Publication
(10) Pub. No.: US 2007/0145162 A1
(43) Pub. Date: Jun. 28, 2007

(54) Nutrient delivery device with filter

(76) Inventor: John Fletcher Macmahon, Western Australia (AU)

Correspondence Address: Kenneth I Kohn;Kohn & Associates, Suite 410, 30500 Northwestern Highway, Farmington Hills, MI, 48334, US

(21) Appl. No.: 10/583,610

(22) PCT Filed: Jan. 28, 2005
(86) PCT No.: PCT/AU05/00093

§ 371 Date: Jun. 20, 2006

(30) Foreign Application Priority Data
Jan. 30, 2004 (AU) 2004-900397

(51) Int. Cl. B05B 1/14

(52) U.S. Cl. 239/462

(57) ABSTRACT

A nutrient delivery device (10) for the delivery of nutrient in the form of a dissolvable fertiliser. The device includes a nutrient receiving chamber (16) which has an inlet at one end for receiving water from a water supply and an outlet at the other end. A filter (18) is provided at the outlet to prevent undissolved nutrient from flowing out to the outlet. In use, water flows through a valve assembly (14) such as a vacuum nutrient from flowing out of the outlet. In use, water flows through a valve assembly (14) such as a vacuum breaker positioned at the inlet to prevent any backflow of water and the water at least partially dissolves the nutrient source in the form of a plurality of prills within the chamber and then flows through the filter to the outlet. The filter comprises an elongate tube member having perforations (32) along the surface and has a conical cap (30) disposed within a path of the water flowing in from the valve assembly.

### FIELD OF THE INVENTION

The present invention relates to a nutrient delivery device, in particular a nutrient delivery device for the delivery of a nutrient in the form of a slow release fertiliser. Preferably, the nutrient is in a prill form.

### BACKGROUND OF THE INVENTION

Application of nutrient, such as fertiliser, to plants in horticulture and agriculture is typically conducted in a manner wherein a large quantity of the nutrient source is applied at a single time or periodically. Single or periodic application of a nutrient source to an area of application may have the undesired effect wherein an unnecessary amount of nutrient is applied to that particular area. This may lead to excess consumption of the nutrient source, which is not only uneconomical, but which also may have the effect of leaching of surplus nutrient into the ground, possibly contaminating groundwater resources.

Further, single or periodic nutrient application is generally unable to accommodate the particular nutrient requirements of a particular plant type or of a particular plant type within a certain environmental condition, either in specific quantity of nutrient applied or rate at which the nutrient is fed to the plant. It is also critical for optimum plant growth, not only that the nutrients be supplied on a regular basis, but also that the correct balance and formula of nutrient be provided.

The present invention attempts to overcome at least in part the aforementioned disadvantages of previous nutrient application methods.

### SUMMARY OF THE INVENTION

In accordance with one aspect of the present invention there is provided a nutrient delivery device, comprising a nutrient receiving chamber for receiving a dissolvable nutrient source, the nutrient receiving chamber having an inlet for receiving water from a water supply, an outlet and a filter, wherein water flowing into the nutrient receiving chamber at least partially dissolves the nutrient source and flows out of the outlet, with the filter being arranged such that undissolved nutrient is prevented from flowing out of the outlet.

### DESCRIPTION OF THE DRAWINGS

The present invention will now be described, by way of example, with reference to the accompanying drawing, in which:

FIG. 1 is a perspective view of a nutrient delivery device in accordance with the present invention;

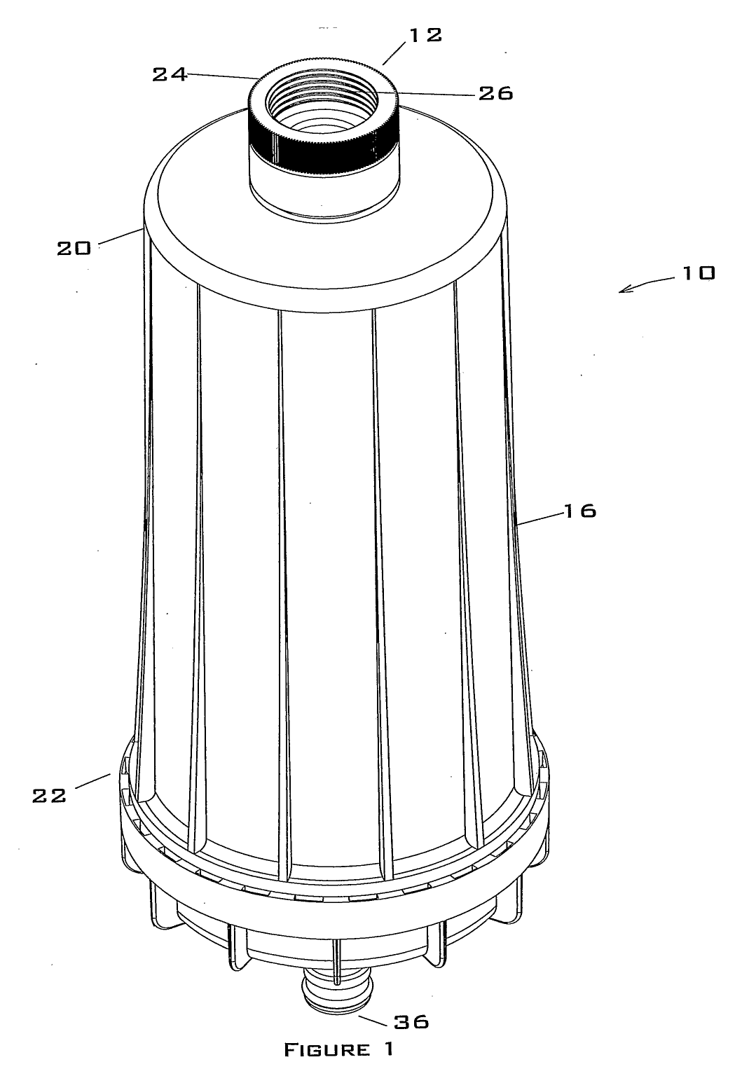

FIG. 2 is a perspective cross sectional view of the nutrient delivery device of FIG. 1; and

FIG. 3 is an exploded view of the nutrient delivery device of FIG. 1.

### DESCRIPTION OF AN EMBODIMENT OF THE INVENTION

Referring to the Figures, there is shown a nutrient delivery device 10 comprising a water inlet 12 with a valve assembly 14 attached thereto. The water inlet 12 and valve assembly 14 are each in fluid communication with a nutrient receiving chamber, which in the present embodiment is a barrel portion 16. The barrel portion 16 houses a filter 18. A suitable nutrient supply, such as prill controlled slow release fertiliser is deposited within the barrel portion 16 and about the filter 18.

The water inlet 12 is provided to enable the nutrient delivery device 10 to be fitted in fluid communication with an outlet water supply such as a tap or faucet, thereby permitting water flow from the water supply to the barrel portion 16. The water inlet 12 may consist of a conventional tap fitting which is able to be locked or screwed onto a tap or the like in a known manner.

The valve assembly 14 attached to the water inlet 12 may be any valve suitable for prevention of backflow of water from the barrel portion 16 back into the water supply, particularly in the event that water flow from the water supply is terminated. In the present embodiment, the valve assembly 14 is a vacuum breaker valve. The vacuum breaker valve acts to creates an air gap between the water supply and the barrel portion 16 of the nutrient delivery device 10 in the event that the water supply is terminated or the water pressure from the water supply becomes less than the water pressure flowing outwardly from the nutrient delivery device 10. The vacuum breaker valve may be any suitable vacuum valve appropriate for the particular conditions and requirements of the place of installation of the nutrient delivery device 10.

The valve assembly 14 is in fluid communication with the barrel portion 16. The barrel portion 16 is an elongate conduit with a first end 20 adjacent to the valve assembly 14 and an opposing second end 22. Each of the ends 20, 22 have a respective opening to permit water flow from the water supply. The volume of the barrel portion 16 may be altered as necessary, to accommodate varying amounts of nutrient source deposited therein.

The barrel portion 16 is connected to the valve assembly 14 at the first end 20 thereof by a socket 24. The socket 24 may be connected to the first end 20 of the barrel portion 16 by a threaded portion 26 about a surface of the first end 20. The provision of the socket 24 enables connection of the valve assembly 14 to the first end 20 of the barrel portion 16 where the diameter of each is of different dimensions. For example, the diameter of the valve assembly 14 is typically larger than that of the socket 24 and threaded portion 26 of the barrel portion 16. The change in diameter from the valve assembly 14 via the socket 24 into the barrel portion 16 further acts to cause water turbulence when the water flows into the barrel portion 16 from the water supply. The water turbulence within the barrel portion 16 is desirable as it acts to assist in dissolving the nutrient source within the barrel portion 16.

The barrel portion 16 is adapted to receive and house the filter 18. The nutrient supply is placed about the filter 18 and within the barrel portion 16. In this manner, any nutrient, which is not substantially dissolved, is unable to flow outwardly from the barrel portion 16.

The nutrient supply is preferably provided in the form of a plurality of prills. Each prill consists of a suitable nutrient supply or fertiliser, with a suitable coating thereabout. Nutrient is slowly released into water incoming into the nutrient delivery device 10 by the nature of the prill and by the flow of water from the water source into the barrel portion 16. The prills absorb water entering into the barrel portion 16 from the water supply, which cause the prills to swell into capsules of substantially liquefied nutrient. The nutrient from the prills are then released through the coating by osmosis and into the water incoming into the barrel portion 16.

The filter 18 is a substantially elongate tube with perforations 32 substantially over the surface thereof. The perforations 32 permit flow of water from the barrel portion 16 into the filter 18 and subsequently out of the second end 22 of the barrel portion 16. In preferred embodiment, the surface area of the filter 18 upon which the perforations 32 are located is of an area in the order of approximately 20 times that of a cross section of the second open end 22 of the barrel portion 16. The relatively greater surface area of the surface of the filter 18 with perforations 32 thereon to cross section of the second open end 22 assists in preventing blockage of the barrel portion 16 with nutrient that has formed a sludge or paste from partially dissolved prills of nutrient.

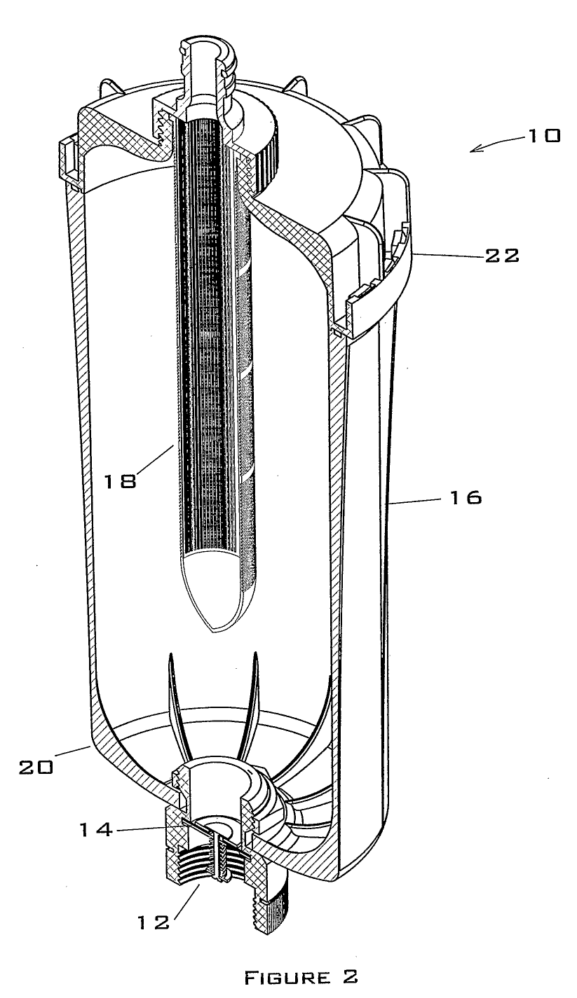

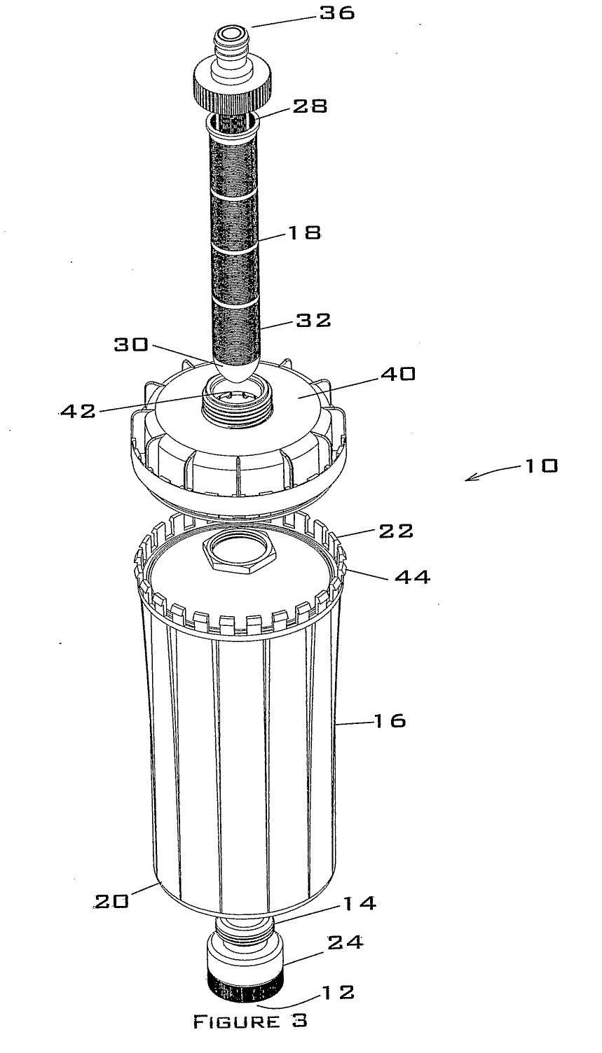

The filter 18 has a first open end 28 adjacent the second end 22 of the barrel portion 16 and a closed second end 30. The closed second end 30 has a cap portion 34 having a solid surface with no perforations thereon. In the embodiment shown in FIGS. 2 and 3, the cap portion 34 is substantially conical in configuration, wherein an apex of the cone points upwardly towards the first end 20 of the barrel portion 16. However, it is envisaged that the cap portion 34 may be any shape or configuration that is able to achieve the purpose of creating turbulence of water flowing into the barrel portion 16 from the water supply. For example, the cap portion 34 may comprise a substantially flat solid portion which is substantially parallel to the first end 20 of the barrel portion 16.

The configuration of the cap portion 34 as described is provided for the purpose of causing further turbulence of the water flowing into the barrel portion 16 from the valve assembly 14. The cap portion 34 of the filter 18 is positioned directly in the path of water flowing from the valve assembly 14 into the barrel portion 16. In this manner, the cap portion 34 acts as a type of baffle, causing water flowing into the barrel portion 16 to abruptly change direction from that of the initial flow path, incoming from the valve assembly 14.

The abrupt change in direction assists in causing water turbulence within the barrel portion 16, thereby causing agitation of the prills within the barrel portion 16. The agitation of the prills results in abrasive contact between adjacent individual prills. This abrasive contact effects further decomposition and dissolution of the prills, permitting the nutrient within the prills to be released into the water within and flowing out of the barrel portion 16.

In a preferred embodiment, the valve assembly 14, socket 24 and barrel portion 16 with filter 18 and nutrient source therein is sealed following the introduction of the nutrient source to the barrel portion 16. Preferably, the introduction of nutrient source and subsequent sealing of the barrel portion 16 is conducted in the manufacturing stage of the nutrient delivery device 10. For example, a seal (not shown) may be provided at each of the ends 20, 22 of the barrel portion 16 to prevent input of solid material into the barrel portion 16. The seal must however be able to facilitate the passage of water flow from the water source and out of the nutrient delivery device 10. As such, the seal may comprise, for example, a portion of mesh, spanning over the cross section of the first and second open ends 20, 22 of the barrel portion 16. In this manner, it is envisaged that the nutrient delivery device 10 will be produced as a single-use device, whereby entry of further or alternative nutrient sources or other material into the barrel portion 16 may be prevented.

In the embodiment shown in the Figures, in particular, FIG. 3, the second open end 22 of the barrel portion 16 is appropriately sealed with a lid 40 having an opening 42 disposed substantially centrally therein. The lid 40 is preferably fitted onto the second end 22 by a snap lock fitting. In the embodiment shown in FIG. 3, the snap lock fitting includes a plurality of protrusions 44 extending outwardly from the second end 22 of the barrel portion 16. The protrusions 44 are engagingly received by a corresponding receiving portion on a lower surface of the lid 40. In this manner, the lid 40 is unable to be removed from the barrel portion 16 once the barrel portion 16 has been appropriately filled with the nutrient source.

The nutrient delivery device 10 further includes an output means 36, adjacent the second end 22 of the barrel portion 16. The output means 36 is in fluid communication with the open end 28 of the filter 18 to enable water containing dissolved nutrient to flow from the barrel portion 16, into the filter 18 and out of the nutrient delivery device 10. The output means 36 is provided as a connector fitting, to enable the nutrient delivery device 10 to be engaged with a delivery means such as a hose or similar device in order to assist application of the water containing dissolved nutrient to the appropriate area, such as plants or crops.

Preferably, the output means 36 is provided as a connecter fitting which permits automatic interengagement of the nutrient delivery device 10 with the hose or other delivery means. Also preferably, the output means 36 is securedly fixed in place, for example, with a chemical bonding agent such as glue, to prevent opening at the second end 22 after the barrel portion 16 has been appropriately filled with the nutrient source.

In use, the barrel portion 16 of the nutrient delivery device 10 is substantially filled with a suitable nutrient source, such as a prill controlled slow release fertiliser. The nutrient source is placed within the barrel portion 16 and externally of the filter 18. The socket 24 and barrel portion 16 with nutrient source and filter 18 therein is then sealed in manufacture to prevent refilling of the barrel portion 16 with any other substance. The socket 24 and barrel portion 16 may be sealed by any suitable means, such as by welding or riveting the aforementioned components together to produce a single-use unit.

The nutrient delivery device 10 may then be connected to a suitable water outlet, such as a tap or faucet connected to a mains water supply, by attaching the water inlet 12 to the water outlet. The nutrient delivery device 10 is further connected at the output means 36 to a suitable delivery means, such as a hose or the like. Water is then introduced into the nutrient delivery device 10 by initiating flow of water from the water outlet in the manner known.

Water flowing from the water outlet is then caused to enter into the water inlet 12, through the valve assembly 14 and into the barrel portion 14 via the socket 24 attached to the first end 20 of the barrel portion 16. The passage of the water through the socket 24 causes some turbulence of the water passing into the barrel portion 16. Water entering into the barrel portion 16 travels along a flow path which encounters the cap portion 32 of the filter 18. The flow of water over and into the cap portion 32 of the filter 18 promotes further turbulence of the water within the barrel portion 16.

The flow of water into the barrel portion 16, together with the resulting turbulence acts to dissolve the nutrient source within the barrel portion 16. Water containing dissolved nutrient is then caused to flow from the barrel portion 16, through the perforations 32 upon the surface of the filter 18. The water containing dissolved nutrient then passes outwardly through the output means 36 adjacent the second end 22 of the barrel portion 16. If connected, the water containing dissolved nutrient further passes through the hose, sprinkler or other suitable delivery means attached to the output means 36.

Modifications and variations as would be apparent to a skilled addressee are deemed to be within the scope of the present invention.

1. A nutrient delivery device, characterized by comprising:
a nutrient receiving chamber for receiving a nutrient source, the nutrient receiving chamber having an inlet at a first end for receiving water from a water supply and an outlet at a second opposing end; and
a filter, comprising an elongate tube member having perforations and being arranged within the nutrient receiving chamber such that the filter has a first open end adjacent the outlet end of the nutrient receiving chamber and a second end, having a cap portion with a solid surface, the cap portion being disposed in a direct path of water flowing from the inlet end into the nutrient receiving chamber;
wherein turbulence is created within the nutrient receiving chamber so as to at least partially dissolve the nutrient source and flows out of the outlet, and the filter prevents undissolved nutrient from flowing out of the outlet.

2. A nutrient delivery device according to claim 1, characterized in that the inlet end has a valve assembly attached thereto, the valve assembly being in fluid communication with the inlet and the nutrient receiving chamber.

3. A nutrient delivery device according to claim 2, characterized in that the valve assembly is a valve adapted to prevent backflow of water from the nutrient receiving chamber to the water supply.

4. A nutrient delivery device according to claim 2, characterized in that the valve assembly is a vacuum breaker valve.

5. A nutrient delivery device according to claim 2, characterized in that the nutrient receiving chamber is a barrel portion, the barrel portion comprising an elongate conduit having the first open inlet end adjacent the valve assembly.

6. A nutrient delivery device according to claim 1, characterized in that the cap portion is conical in configuration, whereby an apex of the cone points towards the first open end of the nutrient receiving chamber.

7. A nutrient delivery device according to claim 1, characterized in that the surface area of the filter upon which the perforations are disposed is at least twenty times a surface area of a cross section of the second open outlet end of the nutrient receiving chamber.

8. A nutrient delivery device according to claim 1, characterized in that nutrient receiving chamber is connected to the valve assembly by a socket.

9. A nutrient delivery device according to claim 8, characterized in that the socket has a diameter smaller relative to a diameter of the nutrient receiving chamber to assist in creation of turbulence in the water flowing from the water supply to the nutrient receiving chamber.

10. A nutrient delivery device according to claim 1, characterized by a sealing means adjacent the inlet end and outlet ends of the nutrient receiving chamber to enclose the nutrient source therein, the sealing means being permeable to water and dissolved nutrient.

11. A nutrient delivery device in accordance with claim 10, characterized in that the sealing means is a mesh disposed adjacent the first and second open ends of the nutrient receiving chamber.

12. A nutrient delivery device according to claim 1, characterized in that the nutrient source is in the form of a plurality of prills.
